(19) United States
(12) Patent Application Publication
(10) Pub. No.: US 2001/0032264 A1
(43) Pub. Date: Oct. 18, 2001

(54) Portable electronic communication device and method

(76) Inventor: Carol A. Rehtmeyer, Wheaton, IL (US)

Correspondence Address: Jacqueline E. Hartt, Ph.D., Allen, Dyer, Doppelt, Milbrath & Gilchrist, P.A., 255 South Orange Avenue, Suite 1401, P.O. Box 3791, Orlando, FL, 32802-3791, US

(21) Appl. No.: 09/756,486

(22) Filed: Jan. 8, 2001

Related U.S. Application Data
(60) Provisional application No. 60/174,884, filed on Jan. 7, 2000.

(51) Int. Cl. G06F 15/16

(52) U.S. Cl. 709/227; 709/200

(57) ABSTRACT

A communication system includes a device connectable to a network through a provider. Email can be sent and retrieved, and the device user is identified by the provider for whom demographic information has been stored. Targeted communication is automatically downloaded to the device for display to the user. The device may be operated in wireless mode via an antenna to communicate with another individual or group of individuals, and the targeted communication relayed as appropriate thereto. A user will also accumulate rewards associated with particular activities which are redeemable for rewards.

### CROSS-REFERENCE TO RELATED APPLICATION

This application claims priority to provisional application 60/174,884, filed on Jan. 7, 2000.

### BACKGROUND OF THE INVENTION

1. Field of the Invention

The present invention relates to portable communication devices and methods, and, more particularly, to such devices and methods for establishing inter- and intranet communication between and to members of a particular group.

2. Description of Related Art

Electronic communications has become a virtually indispensable feature of modem life. Communications between individuals and groups are possible via electronic mail (email) and in real time in so-called “chat rooms” and on instant messaging platforms. Such communications are possible worldwide over the Internet and locally over an intranet.

A portable, battery-operated device is also known for connecting through an available telephone line to retrieve and send email (PocketMail, PocketScience, Inc., Santa Clara, Calif.; devices made by JVC and Sharp). Transmission occurs via an audible modem placed against a telephone handset.

It is also known to place advertisements within screens that appear automatically upon signing on to an Internet server and also upon bringing up a particular site on, for example, the World Wide Web. Some of these sites also give points for making purchases online that are convertible into, for example, frequent flier miles; some sites also give bonuses for making purchases during a particular time period in the form of discounts or extra accumulated points.

### SUMMARY OF THE INVENTION

It is an object of the present invention to provide a portable device for enabling both stored and real-time communications between members of a particular group.

It is another object to provide such a device that does not require a telephone line to operate.

It is a further object to provide such a device that permits a user to join a real-time interchange on one of a plurality of selected topics or among other individuals with a common interest.

It is also an object to provide a communications system that includes a usage-based reward system.

It is an additional object to provide such a system that permits targeted advertising to a preselected user group.

These and other objects are achieved by the portable communication device of the present invention. The device comprises a unitary housing having a plurality of openings into an interior space, the openings for housing and permitting access to input and output means. Into a first opening is affixed an output means, for example, a display screen; into a second opening is affixed an input means, for example, a keyboard. These are not intended as limitations, however, as the input and output means may also comprise another type of device known in the art such as a touch screen that would obviate the need for a keyboard. A third opening is provided for a radio-frequency (rf) transmitter/receiver antenna, for permitting an rf signal to be sent and received. A fourth opening is provided for housing a connector adapted to interface with, for example, a telephone line, although other communications interfaces may also be contemplated. A modem is affixed within the housing and is in electronic communication with the rf antenna and a line connector, for sending and receiving electronic signals either via rf means or via line input, such as over telephone lines by such means as currently known and used in the art.

The keyboard, screen, and modem are all in electronic communication with a processor housed within the interior space of the housing in a configuration such as is commonly known in the art.

The features that characterize the invention, both as to organization and method of operation, together with further objects and advantages thereof, will be better understood from the following description used in conjunction with the accompanying drawing. It is to be expressly understood that the drawing is for the purpose of illustration and description and is not intended as a definition of the limits of the invention. These and other objects attained, and advantages offered, by the present invention will become more fully apparent as the description that now follows is read in conjunction with the accompanying drawing.

### BRIEF DESCRIPTION OF THE DRAWINGS

FIG. 1 is a schematic illustration of the communication device and system of the present invention.

FIG. 2 is a perspective illustration of the device in a closed configuration.

FIG. 3 is a perspective illustration of the device in an open configuration.

### DETAILED DESCRIPTION OF THE PREFERRED EMBODIMENTS

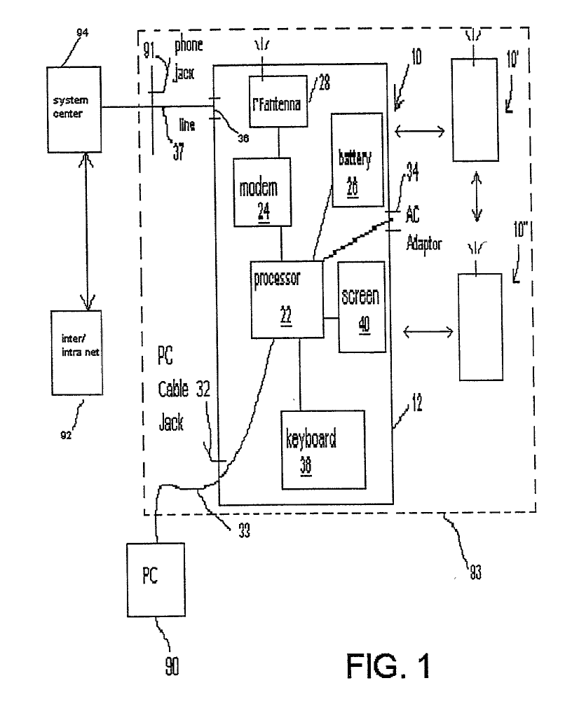

A description of the preferred embodiments of the present invention will now be presented with reference to FIGS. 1-3.

### The Communication Device

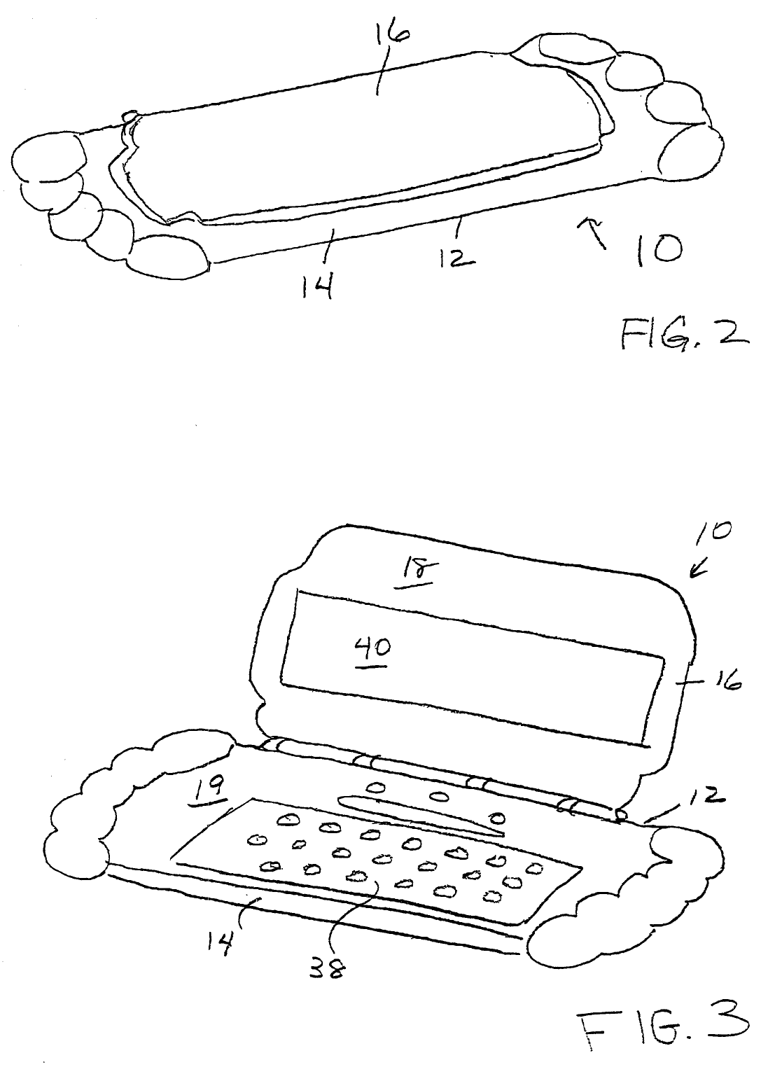

The device 10 of the present invention is contemplated for use as a portable communications unit for accessing the Internet, an intranet, a specific group of individuals, or a particular individual. The device 10 comprises a housing 12 having a base 14 and a screen sector 16 hingedly connected to the base 14 along rear edges thereof. The housing 12 is convertible between a closed configuration (FIG. 2), wherein the screen sector 16 rests atop the base 14 so that its bottom face 18 is closely opposed and in at least partially covering relation to the base's top face 19, and an open configuration (FIG. 3), wherein the screen sector's bottom face 18 and base's top face 19 are accessible and in spaced relation from each other.

Positioned within the base's interior space are a processor 22 and other components in electronic communication therewith: a modem 24 and a battery 26. A radio frequency (rf) antenna 28 is in electronic communication with the modem 24 and is positioned adjacent an opening 30 in the housing 12 to permit signal transmission and receipt. A first jack 32 is provided for making electronic connection via a cable 33 between the processor 22 and an external computer 90 if desired. A second jack 34 is provided for receiving power from an external source such as a wall outlet. A third jack 36 is provided for connecting the modem 24 via a telephone-type or data line 37, for example, to a telephone or cablejack 91. When the unit 10 is turned on, the processor 22 will default to rf mode if there has been no connection established to an external line 37.

User input is achieved via a keyboard 38 positioned within the top face 19 of the base 14, with the keyboard 38 in electronic communication with the processor 22. Output to the user is achieved via a display screen 40 positioned within the bottom face 18 of the screen sector 16, the screen 40 in electronic communication with the processor 22.

### Methods of Using the Communication Device

The communication device 10 of the present invention is contemplated for use in a plurality of ways. In a first method of use, when the device 10 is connected via the modem 24 and a telephone or data line 37 or via rf linkage 28 to the Internet or intranet 92 through the particular service provider 94 serving these devices 10,10′,10″, email can be sent and retrieved and access made to a selected site on the Internet 92 as desired. Upon connection to the provider 94, the device 10 is identified as belonging to a particular individual who has been previously categorized as belonging to a certain demographic group. Targeted advertising is then automatically downloaded to the device 10 for display to the user. It is also contemplated that certain sites will exist that are accessible only by those individuals possessing this type of device 10 and are served by provider 94.

In a second method of use, the device 10 may be operated in rf mode via the modem 24 and antenna 28 to communicate with another individual 10′ or group of individuals 10′,10″ within a geographical area 93 limited by the rf transmission characteristics in that area 93. This mode is advantageous in that it eliminates the costs associated with cellular links. When in this mode, it is also contemplated that any advertisements previously downloaded into the device 10 that have not reached a predetermined expiration date will automatically transfer to another communicating device 10′,10″, thereby augmenting the reach of the advertisement and enhancing its value.

In a third method associated with the use of the communication device 10 of the present invention, a user will accumulate reward “points” associated with such activities as usage time, accessing a particular site, sharing advertising information with other provider members, and making purchases from selected vendors. These points are accumulated at the provider 94 level and are redeemable for rewards such as discounts and products. When in the rf mode, points are accumulated within the device 10 and then uploaded to the provider 94 upon signing on in line mode. The user can access his/her account with the use of a password or access code to check on the account's status.

In additional methods associated with the present invention, the processor 22 will support features such as are known in art, including, but not limited to, calendaring, organizing, and games.

It may be appreciated by one skilled in the art that additional embodiments may be contemplated, including alternate devices having similar functions to those recited as are familiar to those of skill in the art.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the apparatus illustrated and described herein are by way of example, and the scope of the invention is not limited to the exact details of construction.

What is claimed is:

1. A communications system comprising:
a first communication device for a first user having:
means for communicating through a network;
means for transmitting and receiving electromagnetic waves for communicating with a second user having a second communication device;
a processor in electronic communication with the communicating means and the transmitting and receiving means;
storage means in communication with the processor; and
input and output means in electronic communication with the processor for receiving and displaying information to and from a first user;
a provider system having:
means for recognizing the first user initiating a communication through the network; and
means for sending a targeted communication based upon a predetermined criterion based upon a set of stored data on the first user and for inserting the communication into the storage means; and
software means resident within the processor having means for, upon a communication being established by the first user with a second user, relaying the targeted communication to the second user via one of the transmitting and receiving means and the communicating means.

2. The communication system recited in claim 1, wherein the first communication device comprises a portable unit.

3. The communication system recited in claim 1, wherein the first communication device comprises a housing comprising a base and a screen sector connected thereto, wherein the output means comprises the screen sector.

4. The communication system recited in claim 1, wherein the communicating means comprises a modem.

5. The communication system recited in claim 1, wherein the transmitting and receiving means comprises a radio-frequency antenna.

6. The communication system recited in claim 1, wherein the input means comprises a keyboard.

7. The communication system recited in claim 1, wherein the targeted communication comprises an advertisement.

8. The communication system recited in claim 1, wherein the predetermined criterion is selected from at least one of a plurality of demographic data.

9. The communication system recited in claim 1, wherein:
the targeted communication comprises an expiration date;
the software means further has means for determining a current date and means for blocking a relaying of the targeted communication if the current date is past the expiration date.

10. The communication system recited in claim 1, wherein the provider system further comprises means for determining an activity undertaken by the first user and for offering a reward to the first user if the activity is one of a predetermined set of reward-earning activities.

11. The communication system recited in claim 10, wherein the set of reward-earning activities comprises usage time, accessing a particular site via the network, sharing information with the second user, and making a purchase from a selected vendor.

12. The communication system recited in claim 10, wherein the reward comprises at least one of a discount and a product.

13. The communication system recited in claim 10, wherein the set of stored data comprises an account containing data on accumulated reward status of the first user.

14. A communications method comprising the steps of:
permitting a first user to communicate using a first communication device through a network with a site for receiving a communication from a second user;
recognizing the first user;
accessing a database containing information on the first user;
sending via the network a targeted message to the first user;
storing the targeted message on the first communication device;
permitting the first user to communicate with a second communication device of a second user using the first communication device; and
automatically relaying the targeted message from the first communication device to the second communication device.

15. A portable communication device comprising:
a housing having a first, a second, a third, and a fourth opening into an interior space;
input means positioned within the housing and accessible through the first opening;
output means positioned within the housing and accessible through the second opening;
antenna means extending through the third opening;
interface means extending through the fourth opening for communicating with a network;
storage means within the housing;
a processor positioned within the housing and in electronic communication with the input, output, antenna, storage, and interface means; and
software means resident within the processor having means for receiving via the interface means a targeted communication from a provider system and for relaying the targeted communication to another member of the provider system matching a set of predetermined criteria via the antenna means.
